(19) United States
(12) Patent Application Publication
(10) Pub. No.: US 2018/0057340 A1
(43) Pub. Date: Mar. 1, 2018

(54) Mixed drink producing apparatus with a degassing unit as well as household refrigeration apparatus with such a mixed drink producing apparatus

(71) Applicant: BSH HAUSGERAETE GMBH, Muenchen (DE)

(72) Inventors: KUDRET BAYSAL, GIENGEN BRENZ (DE); DELIA HAHN, HEIDENHEIM AN DER BRENZ (DE); CARSTEN WEISS, GIENGEN (DE)

(21) Appl. No.: 15/252,578

(22) Filed: Aug. 31, 2016

(51) Int. Cl. B67D 1/00; F25D 23/12

(52) U.S. Cl. CPC B67D 1/0059; F25D 23/12; B67D 1/0078; B67D 1/0021

(57) ABSTRACT

A mixed drink producing apparatus with a dispensing container, which is formed for receiving a liquid addable to a mixed drink by the mixed drink producing apparatus and which is connected to a dispensing unit of the mixed drink producing apparatus for conducting the liquid from the dispensing container to the dispensing unit, and with a gas adding unit, which is formed for adding a carbonizing gas to the liquid, wherein the mixed drink producing apparatus has a degassing unit, by which the liquid can be degassed from carrier gases before supplying the carbonizing gas. There is also described a household refrigeration apparatus and a method for producing a mixed drink.

### TECHNICAL FIELD

The invention relates to a mixed drink producing apparatus with a dispensing container, which is formed for receiving a liquid addable to a mixed drink by the mixed drink producing apparatus. The dispensing container is connected to a dispensing unit of the mixed drink producing apparatus for conducting the liquid from the dispensing container to the dispensing unit. The mixed drink producing apparatus moreover has a gas adding unit, which is formed for adding a carbonizing gas to the liquid. Furthermore, the invention also relates to a household refrigeration apparatus with such a mixed drink producing apparatus.

### PRIOR ART

From DE 196 15 106 A1, a method and a device for continuously producing soda water or soda-like water are known. A device is disclosed there, in which different liquids like lemonade, beer, wine can be present in different separate containers. Each container is connected to an own tap and is thus separated from the other container. Producing and dispensing a mixed drink of different liquids in the containers is not possible there in the interior of the system itself. Furthermore, the taps are far apart such that introducing liquids from different taps into a drinking vessel at the same time is not possible.

From WO 2007/141321 A2, a household refrigeration apparatus is known, which is formed as a drink apparatus for dispensing a drink at this household refrigeration apparatus itself.

Moreover, cold drink machines are also known, in which alcohol containing mixed drinks, for example cocktails, can be dispensed.

Moreover, mixed drink producing apparatuses for household refrigeration apparatuses are known, which are formed for dispensing cooled mixed drinks and in which a carbonizing gas like carbon dioxide is addable to a liquid of the mixed drink. Therein, it is known that a liquid was stored in a corresponding container in highly carbonized manner. Therein, the liquid is first conducted into the containers with high carrier gas portions to be then carbonized there. Due to the high carrier gas portion, it is required that an increased filling pressure is required and thus increased carbon dioxide demand for carbonizing arises. Moreover, it is known that for avoiding icing of the liquid if it is cooled, air is additionally introduced into the container such that here carrier gas portions, as for example oxygen here too, are also additionally introduced and the enrichment with carrier gas portions is increased.

### BRIEF DESCRIPTION OF THE INVENTION

It is the object of the present invention to provide a mixed drink producing apparatus as well as a household refrigeration apparatus as well as a method, by which the filling pressure of a liquid can be reduced and the demand of carbonizing gas in carbonizing can be reduced.

This object is solved by a mixed drink producing apparatus, a household refrigeration apparatus and a method according to the features of the independent claims.

A mixed drink producing apparatus according to the invention includes at least one dispensing container, which is formed for receiving a liquid addable to an in particular cooled mixed drink by the mixed drink producing apparatus. The dispensing container is connected to a dispensing unit of the mixed drink producing apparatus for conducting the liquid from the dispensing container to the dispensing unit. The mixed drink producing apparatus moreover includes a gas adding unit, which is formed for adding a carbonizing gas to the liquid. An essential idea of the invention is to be regarded in that the mixed drink producing apparatus furthermore has a degassing unit, by which the liquid can be degassed before supplying the carbonizing gas and thus the portion of carrier gases such as for example oxygen can be reduced. By such a configuration, it is achieved that the filling pressure is reduced and moreover the following carbonization can be effected with considerably less carbonizing gas. By the improved diffusion conditions, higher degrees of carbonization are allowed at the same carbonization pressures. Therefore, the invention also allows corresponding advantages in this respect. This then also results in a significantly lower saturation pressure in carbonizing the liquids. Among other things, thus, carbonizing at low pressure is allowed and thereby standard requirements can be reduced. Moreover, better utilization of the carbonizing gas stock is allowed because more drinks can be prepared with the same amount of carbonizing gas, in particular carbon dioxide.

In particular, it is provided that the degassing unit is formed for vacuum degassing. In particular, the storage tank, which is formed by the dispensing container, is hermetically sealed thereby. Correspondingly present overflow lines are then closable, in particular by valves. This dispensing container is evacuated before the liquid is pumped into this dispensing container.

However, it can also be provided that the degassing unit is formed for thermal degassing. Therein, dissolved gases are expelled from the liquid. Therein, the liquid is to be taken to the boiling state. In this boiling state, the solubility of gases and liquid is nearly zero. Preferably, a fine distribution via trickling sheet cascades acts in supporting manner. The thermal degassing can be performed in the positive pressure range or in the negative pressure range. The heating to the boiling temperature can preferably be effected by a heating steam, which flows into the degassing unit at the bottom and flows through it in counterflow to the top. The gases expelled therein are in particular discharged with the bridge steam via the bridge outlet into a degasser dome of the degassing unit.

It can also be provided that the degassing unit is formed for column degassing. Herein, in particular a column with fillers or structured packing for producing a specific surface as large as possible is sprinkled with the liquid to be degassed. This liquid in particular flows downwards via the packing elements and collects in a column bottom. In particular, the carbonizing gas flows in counterflow to the liquid upwards through the column at the same time. Due to the relatively large design height of the column, the contact time between the liquid and the stripping gas is sufficiently long. Column degassing operations are in particular advantageous and also very low in maintenance due to their construction simple in terms of plant.

It can also be provided that the degassing unit is formed for pressure degassing with stripping gas. The employment of stripping gas causes disturbance of the balance of the carrier gases dissolved in the liquid. The concentration of the oxygen in the gas phase is lowered by the stripping gas. The phase balance shifts and oxygen transitions from the liquid into the gas phase. In particular, carbon dioxide can be employed as the striping gas, which has very good water solubility on the one hand and a very good displacing effect on the dissolved oxygen on the other hand. As a further possibility of a stripping gas, nitrogen can be employed. This gas is inexpensive and its emission does not have negative influences on the climate.

Moreover, it can be provided that the degassing unit is formed for degassing by catalytic reactions. In this degassing, which is also called spray degassing, the liquid is cold atomized with carbon dioxide in one or more evacuated containers.

Moreover, it can also be provided that the degassing unit is formed for membrane degassing. Herein, the liquid is externally conducted around the hydrophobic hollow fibers in special membrane modules, and the carbon dioxide flows in the interior in counterflow thereto. The hollow fibers generate a very large contact surface between the liquid to be degassed and the stripping gas and the membrane modules only pass gases, but no liquid. The membrane degassing is a compact and efficient degassing method with very low residual oxygen values as well as low carbon dioxide consumptions and low energy demand with small degassing powers.

In particular, it is provided that the degassed liquid thus reduced from the carrier gasses is then also stored in the dispensing container in the carbonized state.

It is in particular provided that the mixed drink producing apparatus has at least one further dispensing container, which is formed for receiving a further liquid addable to the mixed drink by the mixed drink producing apparatus. This further dispensing container is connected to the dispensing unit of the mixed drink producing apparatus for conducting the further or second liquid from the further dispensing container to the dispensing unit.

Thereby, the flexibility and variability for producing mixed drinks can be increased. In particular, it is provided that a first liquid is water or contains water and the further or second liquid is alcohol or contains alcohol. The two liquids in particular have different freezing points.

In particular, a cooled mixed drink can be dispensed by the mixed drink producing apparatus. Thereto, it is preferably provided that a cooling device of the mixed drink producing apparatus is formed for cooling the at least one dispensing container. Preferably, the cooling device is formed for cooling the dispensing container and, if it is present, for cooling the further dispensing container.

The cooling device can in particular be a refrigeration circuit, which has a condenser, a compressor and at least one evaporator. Preferably, the evaporator is thermally coupled to the dispensing container.

Furthermore, the invention also relates to a household refrigeration apparatus for storing and preserving food, such as for example a refrigerator or a freezer or a combined refrigerator-freezer. The household refrigeration apparatus in particular includes a housing, in which a receiving space for food is formed. The household refrigeration apparatus moreover also includes a mixed drink producing apparatus according to the invention or an advantageous configuration thereof.

In addition, it can also be provided that the mixed drink producing apparatus is formed for receiving a capsule, in which additives, which can be added to the mixed drink. Additives can be powdery or gelatinous or also liquid. In this context, the capsule can then be inserted into a dispensing area of the mixed drink producing apparatus and this ingredient of the capsule can then also be automatically dispensed or added or already be added upon dispensing the mixed drink.

In an advantageous implementation, it is provided that the mixed drink producing apparatus is disposed in a receiving area of the household refrigeration apparatus in particular separate from the receiving space for food. This receiving area can be formed in an interior container bounding the receiving space with its walls. However, it can also be provided that the receiving area is formed in an interior container separate from this interior container bounding the receiving space with its walls. These interior containers or this interior container are or is disposed in the housing.

The receiving space, in particular only the receiving space, is closable on the front side by a door pivotably supported at the housing. In this context, it can be provided that the household refrigeration apparatus is formed such that only one receiving space is present, which is for example a refrigerating compartment or a freezing compartment, which is closable by an own door. However, it can also be provided that such a single receiving space is closable by two doors, which are swing doors. However, it is similarly possible that with two separate receiving spaces, for example a refrigerating space and a freezing space, each of these receiving spaces is closable by a separate door.

Preferably, the mixed drink producing apparatus is accessible and exposed on the front side and not closed and covered by a door.

In an advantageous implementation, it is provided that the mixed drink producing apparatus is arranged drawer-like in the receiving space and thus is retractable and extractable in depth direction of the household refrigeration apparatus. Thereby, the operability for dispensing mixed drinks can be simplified. An essential advantage of this configuration is to be regarded in that the accessibility to the housing of the mixed drink producing apparatus is simplified. In particular the accessibility to the containers and/or other further components in the housing is thereby allowed. It can then be provided that in the extracted state the interior of the housing of the mixed drink producing apparatus can be accessed for example via openings in side walls closable by flaps.

The drink producing apparatus is also to be referred to as mixed drink producing apparatus if the drink to be dispensed has at least one liquid and an addition medium or at least two different liquids.

With indications of “top”, “bottom”, “front”, “rear”, “horizontal”, “vertical”, “depth direction”, “width direction”, “height direction” etc., the positions and orientations with intended use and intended arrangement of the apparatus and with an observer then standing in front of the apparatus and looking towards the apparatus are specified.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim. Moreover, implementations and feature combinations are to be considered as disclosed, in particular by the implementations set out above, which extend beyond or deviate from the feature combinations set out in the relations of the claims.

### BRIEF DESCRIPTION OF THE DRAWINGS

Below, embodiments of the invention are explained in more detail based on schematic drawings. There show:

FIG. 1 a perspective partial representation of an embodiment of a household refrigeration apparatus according to the invention; and

FIG. 2 a schematic representation of components of an embodiment of a mixed drink producing apparatus.

### PREFERRED IMPLEMENTATION OF THE INVENTION

In the figures, identical or functionally identical elements are provided with the same reference characters.

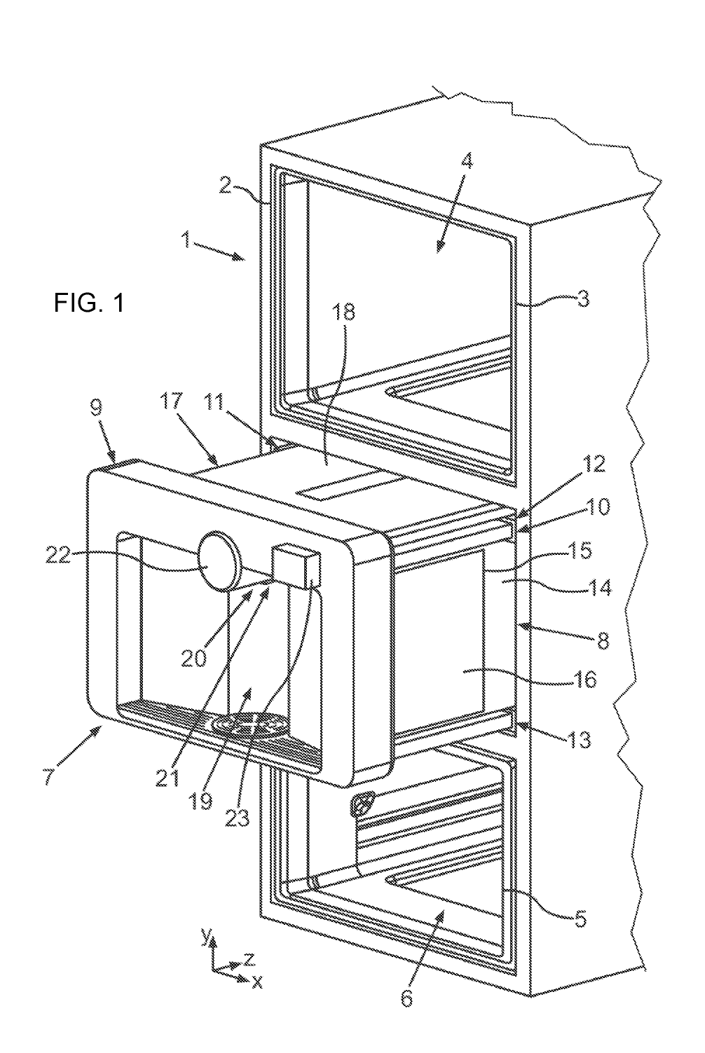

In FIG. 1, a household refrigeration apparatus 1 is illustrated in certain areas in a simplified perspective representation. Here, the household refrigeration apparatus 1 is for example a combined refrigerator-freezer. The household refrigeration apparatus 1 is formed for storing and preserving food. It includes a housing 2, in which a first interior container 3 is disposed. Walls of the interior container 3 bound a first receiving space 4 for food, wherein this receiving space 4 is a refrigerating compartment.

Moreover, the household refrigeration apparatus 1 includes a further interior container 5, which bounds a second receiving space 6 with its walls, which is a freezing compartment. The two receiving spaces 4 and 6 are separated from each other. In the shown embodiment, the receiving spaces 4 and 6 are disposed one above the other in vertical direction and thus in height direction (y-direction). In the embodiment, they are preferably closable by non-shown, respectively separate doors, which are in particular pivotably fastened to the housing 2.

Moreover, the household refrigeration apparatus 1 includes a mixed drink producing apparatus 7.

However, the mixed drink producing apparatus 7 can also be formed as a separate independent apparatus and thus be installed independently of a household refrigeration apparatus 1 and operable independently thereof.

The mixed drink producing apparatus 7 is disposed in a receiving area 8 of the housing 2. This receiving area 8 is separated from the receiving spaces 4 and 6. It can be provided that the receiving area 8 is bounded by walls of a separate interior container, which is also foamed in the housing 2. However, the receiving area 8 can also be formed integrated in the interior container 3 or the interior container 5.

In the embodiment, it is provided that the receiving area 8 is disposed between the receiving space 4 and the receiving space 6 in height direction.

The mixed drink producing apparatus 7 is disposed accessible from the front side and thus from the front and the visible side. In particular, it is not closable and thus not coverable on the front side by a door.

The mixed drink producing apparatus 7 has a housing 9.

In the embodiment, it is provided that the housing 9 and thus the entire mixed drink producing apparatus 7 can be extracted from and again retracted into the receiving area 8 in depth direction and thus in horizontal direction corresponding to the z-direction corresponding to a drawer. In FIG. 1, the completely extracted state is shown.

Here, it is preferably provided that the horizontal displaceability is formed by a displacing device 10, which has multiple supporting positions. In the embodiment, it is provided that the displacing device 10 includes at least two, in particular four supporting positions. In the embodiment, they are formed as rails, which can also be extraction rails. In particular, here are disposed a first rail 11 in an upper left corner area, a second rail 12 in the upper right corner area, a third rail 13 in the lower right corner area and a further rail not recognizable in FIG. 1 in the lower left corner area. By this four-position support, a very secure and spread- and tilt-proof displacement, respectively, of the housing 9 is allowed.

Thus, the mixed drink producing apparatus 7 is advantageously displaceably supported in the interior container 8. Advantageously, the displacing device 10 also has an extraction stop, by which the drink apparatus formed in particular as a mixed drink producing apparatus 7 is secured in position in a completely extracted position shown in FIG. 1. Thus, over-extraction cannot be effected such that the mixed drink producing apparatus 7 cannot fall out to the front and tilt downwards, respectively.

Advantageously, it is also provided that the displacing device 10 has a displacing protection, by which the mixed drink producing apparatus 7 is disposed extraction-secured in the position completely retracted into the receiving area 8. Thereby too, undesired slipping out or protruding to the front then present is avoided. Undesired leakage or dripping of a liquid or hitting thereto is thereby prevented. This displacement protection can be a locking device. However, in addition or instead of it, a magnetic mount can also be provided.

Advantageously, an access 15 is formed at a vertical sidewall 14 of the housing 9, which is closed by a flap 16. After opening the flap 16, the interior of the housing 9 can be accessed such that the simple and unrestricted accessibility is allowed for purposes of exchange or filling. Additionally or instead of it, it can also be provided that a corresponding access is formed at an opposing further vertical sidewall 17 and/or at least one such access 15 is formed at a ceiling wall 18 of the housing 9.

Moreover, the mixed drink producing apparatus 7 includes a recess or placing bay 19 on the front side, into which a drinking vessel can be placed, by which the mixed drink to be produced and dispensed by the mixed drink producing apparatus 7 can then be collected. The mixed drink producing apparatus 7 includes a dispensing unit 20 with in particular a single outlet or a dispensing opening 21. Preferably, it can be provided that an own outlet is respectively present for discharging each liquid from a container. Moreover, it can also be provided that an additive in powder form or gel form or further liquid form can be admixed to this mixed drink to be produced, which can be produced and thus mixed from at least two different liquids. Thereto, it can in particular be provided that a capsule receptacle 22 is formed, into which a capsule having the mentioned additive or an addition medium can be inserted. Upon dispensing the mixed drink, this ingredient or additive is then removed from the capsule and added to the mixed drink in particular before or after dispensing into the drinking vessel effected via the dispensing opening 21.

Moreover, it can in particular be provided that the mixed drink producing apparatus 7 has a capsule storage 23 or a capsule stock. A capsule or multiple capsules can be stored in this capsule storage 23 such that they are always present locally at the apparatus itself. In an advantageous implementation, it can be provided that this capsule storage 23 is cooled such that the capsules located therein can also be stored correspondingly cooled.

Preferably, it is provided that the capsule storage 23 can be opened by push-push mechanics and the capsules received therein are then freely accessible for example in the form of a displaceable storage in the form of a rail and for example can then be simply removed from above.

Moreover, it can also be provided that the mixed drink producing apparatus 7 has a cartridge for admixing carbon dioxide into the mixed drink. Thereto, the accessibility for cartridge exchange is allowed via at least one present access 15. In an advantageous implementation, it is provided that the mixed drink producing apparatus 7 is connected to a water connection external to household apparatus such that supply of water is for example allowed via a house water network. This has the additional advantage that a liquid to be added to the mixed drink as water does not have to be stored in a largely dimensioned container in the mixed drink producing apparatus 7 but that this container can then be smaller dimensioned and can be refilled depending on demand and adapted to situation. It can then also be provided that such a water supply for producing the mixed drink is not supplied from the tank or the container provided for receiving this liquid in the mixed drink producing apparatus 7, but additionally or instead thereof can also be passed directly from this line to the dispensing unit 20 and thus also to the dispensing opening 21.

Thereby, in particular in production of hot drinks instead of a cold drink, the required energy for heating is reduced since the initial temperature of the water is higher. If carbonization of the mixed drink should then be desired, thus, this can be allowed via admixture of carbonized cold water, which is cooled in the mixed drink producing apparatus 7, or via a carbonized second liquid, which is then present in the second container.

It is in particular provided that the mixed drink producing apparatus 7 has a first container, in which a first liquid with a first freezing point, in particular water, is then provided or stored to then provide it for producing and dispensing a mixed drink depending on demand. Moreover, the mixed drink producing apparatus 7 includes a second container separated therefrom, which is formed for receiving a second liquid different from the first liquid, which has a freezing point different form the first liquid. In particular, the first liquid is water and the second liquid is alcohol such that the mixed drink can also be an alcoholized mixed drink.

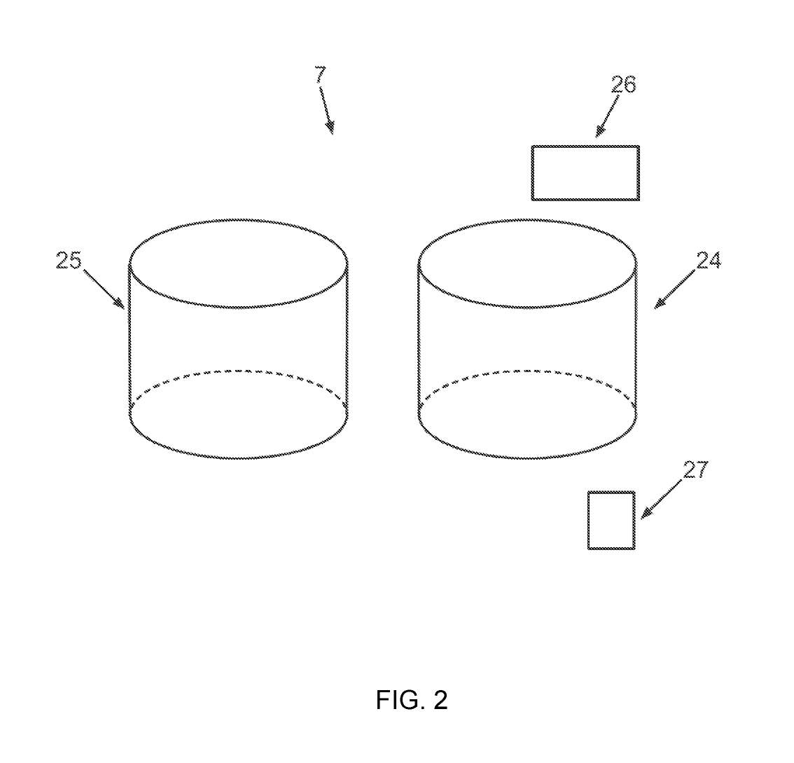

In FIG. 2, a dispensing container 24 is shown in a schematic representation, which presents a first dispensing container of the mixed drink producing apparatus 7. In particular, this dispensing container 24 is formed for receiving a first liquid, which can be water or contain water. The mixed drink producing apparatus preferably includes at least one further dispensing container 25 in the embodiment, which is formed for receiving a further or second liquid, which is alcohol or contains alcohol. Both dispensing containers 24 and 25 are connected to the dispensing unit 20 and in particular the dispensing opening 21. It can be provided that upon producing a cooled mixed drink from both liquids, they are already mixed before reaching the dispensing opening 21 and thus a jet of the mixed liquids exits from the dispensing opening 21.

The mixed drink producing apparatus 7 includes a cooling device, in particular a refrigeration circuit, by which the dispensing container 24 and/or the further dispensing container 25 can be cooled in particular from the outside. Thereby, the liquids located therein are also cooled. In particular, the refrigeration circuit has a condenser and a compressor as well as two separate evaporators, wherein each one evaporator is thermally coupled to one of the dispensing containers 24 and 25.

The mixed drink producing apparatus 7 moreover includes a degassing unit 26. This degassing unit 26 is formed for degassing the first liquid and/or the second liquid. Thus, carrier gases in the liquid can be discharged by the degassing unit 26, wherein this is in particular effected before carbonization of the respective liquid and thus before the addition of in particular carbon dioxide to the respective liquid. For carbonizing, the mixed drink producing apparatus 7 includes a gas adding unit 27, by which the carbonizing gas can be added to the liquid and/or the further liquid. In particular, the addition of the carbonizing gas to at least one of these liquids is effected if this liquid is degassed by the degassing unit 26 and is in particular then still in the dispensing container 24 and/or 25.

The degassing unit 26 can in particular be formed for vacuum degassing. However, it can also be formed for thermal degassing or for column degassing. The degassing unit 26 can also be formed for pressure degassing with stripping gas. Furthermore, the degassing unit 26 can be formed for degassing by a catalytic reaction. Moreover, the degassing unit 26 can also be formed for membrane degassing.

### LIST OF REFERENCE CHARACTERS

1 Household refrigeration apparatus
2 housing
3 interior container
4 first receiving space
5 interior container
6 second receiving space
7 mixed drink producing apparatus
8 receiving area
9 housing
10 displacing device
11 rail
12 rail
13 rail
14 sidewall
15 access
16 flap
17 sidewall
18 ceiling wall
19 placing bay
20 dispensing unit
21 outlet
22 capsule receptacle
23 capsule storage
24 dispensing container
25 dispensing container
26 degassing unit
27 gas adding unit

1. A mixed drink producing apparatus, comprising:
a dispensing unit for dispensing liquid from the mixed drink producing apparatus,
a dispensing container, which is formed for receiving a first liquid addable to a drink by the drink producing apparatus, wherein
the dispensing container is connected to the dispensing unit of the drink producing apparatus for conducting the liquid from the dispensing container to the dispensing unit,
a gas adding unit, which is formed for adding a carbonizing gas to the liquid,
a degassing unit, by which the liquid can be degassed from carrier gases before supplying the carbonizing gas.

2. The mixed drink producing apparatus according to claim 1, wherein the degassing unit is formed for vacuum degassing.

3. The mixed drink producing apparatus according to claim 1, wherein the degassing unit is formed for thermal degassing.

4. The mixed drink producing apparatus according to claim 1, wherein the degassing unit is formed for column degassing.

5. The mixed drink producing apparatus according to claim 1, wherein the degassing unit is formed for pressure degassing with stripping gas.

6. The mixed drink producing apparatus according to claim 1, wherein the degassing unit is formed for degassing by catalytic reactions.

7. The mixed drink producing apparatus according to claim 1, wherein the degassing unit is formed for membrane degassing.

8. The mixed drink producing apparatus according to claim 1, wherein the degassed and carbonized liquid is stored in the dispensing container.

9. The mixed drink producing apparatus according to claim 1, wherein the mixed drink producing apparatus has at least one further dispensing container, which is formed for receiving a further liquid addable to the mixed drink by the mixed drink producing apparatus and which is connected to the dispensing unit of the mixed drink producing apparatus for conducting the liquid from the further dispensing container to the dispensing unit.

10. The mixed drink producing apparatus according to claim 9, wherein the two liquids have different freezing points.

11. A household refrigeration apparatus with a housing, in which a receiving space for food is formed, and with a mixed drink producing apparatus having:
a dispensing unit for dispensing liquid from the drink producing apparatus,
a dispensing container, which is formed for receiving a first liquid addable to a drink by the drink producing apparatus, wherein
the dispensing container is connected to the dispensing unit of the drink producing apparatus for conducting the liquid from the dispensing container to the dispensing unit,
a gas adding unit, which is formed for adding a carbonizing gas to the liquid,
a degassing unit, by which the liquid can be degassed from carrier gases before supplying the carbonizing gas.

12. A method for producing a mixed drink by a mixed drink producing apparatus having the following steps of:
providing a dispensing unit for dispensing liquid from the drink producing apparatus,
providing a dispensing container, which is formed for receiving a first liquid addable to a drink by the drink producing apparatus,
connecting the dispensing container to the dispensing unit for conducting the liquid from the dispensing container to the dispensing unit,
adding a carbonizing gas to the liquid by a gas adding unit of the mixed drink producing apparatus,
degassing the liquid from carrier gases by a degassing unit of the mixed drink producing apparatus before supplying the carbonizing gas.
